(19) United States
(12) Patent Application Publication
(10) Pub. No.: US 2008/0230944 A1
(43) Pub. Date: Sep. 25, 2008

(54) METHOD FOR PRODUCING CELLULOSE ACYLATE FILM

(75) Inventors: Toshinao ARAI, Minami-ashigara-shi (JP); Hiroaki SATA, Minami-ashigara-shi (JP); Takahiro MOTO, Minami-ashigara-shi (JP); Akihiro IKEYAMA, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/050,732

(22) Filed: Mar. 18, 2008

(30) Foreign Application Priority Data
Mar. 20, 2007 (JP) 2007-073312

(51) Int. Cl. B29D 7/01

(52) U.S. Cl. 264/212

(57) ABSTRACT

A dope is cast onto a drum. A casting film is cooled and solidified by the drum. The casting film is peeled as a film containing a solvent. The peeled film is guided to a tenter. In the tenter, in a first drying step, the film is dried by dry air from an air duct while being stretched in the width direction in a state that side edge portions of the film are held by pins. Thereafter, in a second drying step, the film is dried while tension is applied to the film in the width direction. A first ratio calculated by (a moving speed of the pins)/(a rotation speed of the drum), a second ratio calculated by L2/L1, and a third ratio calculated by L3/L2 satisfy 0.94≦(the first ratio)/{(the second ratio)·(the third ratio)}≦0.97.

### FIELD OF THE INVENTION

The present invention relates to a method for producing a cellulose acylate film. More specifically, the present invention relates to a cellulose acylate film for use in a liquid crystal display with high luminance.

### BACKGROUND OF THE INVENTION

Performance required for a liquid crystal display (LCD) is becoming increasingly higher. In particular, it is demanded to reduce changes in optical properties of the LCDs caused by environment changes. The LCD has a structure in which polymer films are layered. As a degree of orientation of polymer molecules in a polymer film increases, amounts of changes in the optical properties of the LCD caused by environmental changes increase.

An LCD market is growing at such a rapid pace that an increase in the number of polymer film production apparatuses cannot catch up with a large increase in demands. Accordingly, it becomes necessary to increase production using existing production apparatuses. Generally, a solution casting method is used to produce a cellulose acylate film for use in the LCD since the solution casting method facilitates achieving excellent optical properties. In order to increase a production speed, a cooling casting method is used. In the cooling casting method, a casting film is cooled to speed up solidification, and peeled off when the casting film is in a gel state (see, for example, Japanese Patent Laid-Open Publication No. 2006-306025).

However, in the cooling casting method, it becomes necessary to increase tension applied to the casting film in a conveying direction during a drying process as the production speed is increased. This is because the casting film peeled off by the cooling casting method contains a significantly larger amount of solvent than the film peeled off after being dried. Accordingly, the self supporting property of the casting film is very low, which makes the casting film loosened and difficult to convey without the application of the tension in the conveying direction. However, as the tension in the conveying direction increases, the degree of orientation of cellulose acylate molecules in the conveying direction increases. As a result, humidity dependence of an in-plane retardation Re of the cellulose acylate film increases.

As well known, a retardation film has an in-plane retardation Re and a retardation Rth in the thickness direction. The Re and the Rth are calculated by the following mathematical expressions (1) and (2) respectively. The “in-plane” refers to a plane direction of the film, namely, a direction of the plane vertical to the thickness direction of the film.

Re=(nx−ny)×d (1)

(wherein “nx” is a refractive index in a slow axis direction in the in-plane of the film, “ny” is a refractive index in a fast axis direction in the in-plane of the film, and “d” is a thickness (unit: nm) of the film.)

Rth={(nx+ny)/2−nz}×d (2)

(wherein “nx” is a refractive index in a slow axis direction in the in-plane of the film, “ny” is a refractive index in a fast axis direction in the in-plane of the film, and “d” is a thickness (nm) of the film.)

As the humidity dependence of the Re of the cellulose acylate film increases, amounts of changes in the optical properties of the LCD increase, in particular, humidity dependence of the optical properties increases. Humidity dependence of the retardation Re is obtained by a mathematical expression|(a retardation Re at low humidity)−(a retardation Re at high humidity)|. High humidity dependence means that the value obtained by the above mathematical formula is large.

### SUMMARY OF THE INVENTION

In view of the foregoing, an object of the present invention is to provide a method of producing a cellulose acylate film in which humidity dependence of an in-plane retardation Re is reduced in a shorter time than conventional methods. In order to achieve the above and other objects, the producing method of the present invention, in which a casting film is formed by continuously casting a dope containing cellulose acylate and a solvent from a casting die onto a casting surface of a cooled drum, includes a peeling step, a first drying step, and a second drying step. In the peeling step, the casting film is solidified by cooling and peeled off from the drum as a wet film. In the first drying step, the wet film is dried using a drying device while the wet film is stretched in a width direction using holders which hold side edge portions of the wet film. In the second drying step after the first drying step, the wet film is dried while tension is applied to the wet film in the width direction in a state that the side edge portions of the wet film are held. A first ratio calculated by (a moving speed (unit: m/min) of the holders)/(a rotation speed (unit:m/min) of the drum), a second ratio calculated by L2/L1, and a third ratio calculated by L3/L2 satisfy 0.94≦(the first ratio)/{(the second ratio)·(the third ratio)}≦0.97 when L1 is a width of the wet film before the stretching in the first drying step, L2 is a width of the film after the stretching in the first drying step, and L3 is a width of the film at the end of the second drying step.

It is preferable that the first drying step is ended before a residual solvent content of the wet film reaches 50%. It is preferable that the widths L2 and L3 satisfy 0≦{(L2−L3)/L3}×x 100≦10.

The present invention is capable of producing the cellulose acylate film in which humidity dependence of the retardation Re is reduced in a shorter time than conventional methods, and increasing production using existing apparatuses.

### BRIEF DESCRIPTION OF THE DRAWINGS

The above and other subjects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1 is a schematic view of a dope producing apparatus;

FIG. 2 is a schematic view of a solution casting apparatus of the present invention;

FIG. 3 is a schematic view of a film held by pins in a tenter; and

FIG. 4 is a schematic view showing an increase and a decrease in width of the film in the tenter.

### DETAILED DESCRIPTION OF THE PREFERRED EMBODIMENTS

Hereinafter embodiments of the present invention are described in detail. However, the present invention is not limited to the following embodiments.

In cellulose acylate, it is preferable that a degree of esterification of hydroxyl group of cellulose with carboxylic acid, namely, a degree of substitution for acyl group (hereinafter referred to as acyl group substitution degree) satisfies all of the following mathematical expressions (I)-(III).

2.5≦A+B≦3.0 (I)

0≦A≦3.0 (II)

0≦B≦2.9 (III)

In these mathematical expressions (I) to (III), A and B are the acyl group substitution degrees. Acyl group of A is acetyl group. Acyl group of B has 3 to 22 carbon atoms.

The cellulose is constructed of glucose units making β-1,4 combination, and each glucose unit has a free hydroxyl group at second, third and sixth positions. Cellulose acylate is a polymer in which a part of or the entire of the hydroxyl groups are esterified so that the acyl group with two or more carbons substitutes for hydrogen. The degree of substitution for the acyl groups in cellulose acylate is a degree of esterification of the hydroxyl group at second, third or sixth position in cellulose. Accordingly, when all (100%) of the hydroxyl group at the same position are substituted, the degree of substitution at this position is 1. In the cellulose acylate, when the hydroxyl groups at second, third, and sixth positions are 100% esterified, the degree of substitution is 3.

When the degrees of substitution of the acyl groups for the hydroxyl group at the second, third or sixth positions are respectively described as DS2, DS3 and DS6, the total degree of substitution of the acyl groups for the hydroxyl group at the second, third and sixth positions (namely DS2+DS3+DS6) is preferably in the range of 2.00 to 3.00 and more preferably in the range of 2.22 to 2.90. It is especially preferable that DS2+DS3+DS6 is in the range of 2.40 to 2.88. Further, DS6/(DS2+DS3+DS6) is preferably at least 0.32, and more preferably 0.322. It is especially preferable that DS6/(DS2+DS3+DS6) is in the range of 0.324 to 0.340.

One or more sorts of acyl group may be contained in the cellulose acylate of the present invention. When two or more sorts of the acyl groups are used, it is preferable that one of them is acetyl group. If the total degree of substitution of the acetyl groups for the hydroxyl group and that of acyl groups other than the acetyl group for the hydroxyl group at the second, third and sixth positions are respectively described as DSA and DSB, the value DSA+DSB is preferably in the range of 2.2 to 2.86, and especially preferably in the range of 2.40 to 2.80. It is preferable that the DSB is at least 1.50. It is especially preferable that the DSB is at least 1.7. Further, in the DSB, the percentage of the substituent for the hydroxyl group at the sixth position is preferably at least 28%, more preferably at least 30%, especially preferably at least 31% and more especially preferably at least 32%. Further, a value DSA+DSB at the sixth position of the cellulose acylate is preferably at least 0.75, more preferably at least 0.80, and especially preferably at least 0.85. With the use of the cellulose acylate satisfying the above conditions, a dope having excellent solubility and that having low viscosity and excellent filterability are prepared. The above described cellulose acylate is particularly preferable when a chlorine-free organic solvent is used.

Acyl group having at least 2 carbon atoms may be aliphatic group or aryl group, and is not especially restricted. Examples of the cellulose acylate are alkylcarbonyl ester, alkenylcarbonyl ester, aromatic carbonyl ester, aromatic alkylcalbonyl ester and the like. The cellulose acylate may be also esters having other substituents. The preferable substituents are propionyl group, butanoyl group, pentanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphtylcarbonyl group, cinnamoyl group and the like. Among them, propionyl group, butanoyl group, dodecanoyl group, octadecanoyl group, t-butanoyl group, oleoyl group, benzoyl group, naphtyl carbonyl group, cinnamoyl group and the like are particularly preferable, and propionyl group and butanoyl group are especially preferable.

It is preferable that not less than 90 wt. % of the cellulose acylate which is a raw material of the dope has a particle diameter of 0.1 mm to 4 mm.

Cellulose acylate is detailed in paragraphs [0140] to [0195] in Japanese Patent Laid-Open Publication No. 2005-104148. These descriptions may be applied to the present invention.

Additives such as solvents, plasticizers, deterioration inhibitors, UV absorbents, optical anisotropy controllers, dyes, matting agents, and peeling agents are detailed in paragraphs [0196] to [0516] of Japanese Patent Laid-Open Publication No. 2005-104148. These descriptions may be applied to the present invention.

Solvent compounds for preparing the dope are aromatic hydrocarbon (for example, benzene toluene and the like), halogenated hydrocarbons (for example, dichloromethane, chlorobenzene and the like), alcohols (for example methanol, ethanol, n-propanol, n-butanol, diethyleneglycol and the like), ketones (for example acetone, methylethyl ketone and the like), esters (for example, methylacetate, ethylacetate, propylacetate and the like), ethers (for example tetrahydrofuran, methylcellosolve and the like) and the like. In the present invention, the dope refers to a polymer solution or a dispersion liquid obtained by dissolving or dispersing polymer(s) in a solvent.

The halogenated hydrocarbons having 1 to 7 carbon atoms are preferable, and dichloromethane is most preferable as the solvent of TAC. In view of physical properties such as solubility of TAC, peelability of a casting film from a support, mechanical strength and optical properties of the film, it is preferable to use at least one sort of the alcohols having 1 to 5 carbon atoms with dichloromethane. The content of the alcohols is preferably in the range of 2 wt. % to 25 wt. %, and especially in the range of 5 wt. % to 20 wt. % to total solvent compounds in the solvent. Specific examples of the alcohols are methanol, ethanol, n-propanol, isopropanol, n-butanol, and the like. It is preferable to use methanol, ethanol, n-butanol or a mixture thereof.

In order to minimize the influence on the environment, the dope may be prepared without dichloromethane. In this case, the solvent containing ethers with 4 to 12 carbon atoms, ketones with 3 to 12 carbon atoms, esters with 3 to 12 carbon atoms, or a mixture of them may be used. The ethers, ketones, and esters may have a cyclic structure. At least one solvent compound having at least two functional groups thereof (—O—, —CO—, and —COO—) may be contained in the organic solvent. The solvent may contain other functional group such as alcoholic hydroxyl group in its chemical structure.

[Dope Producing Method]

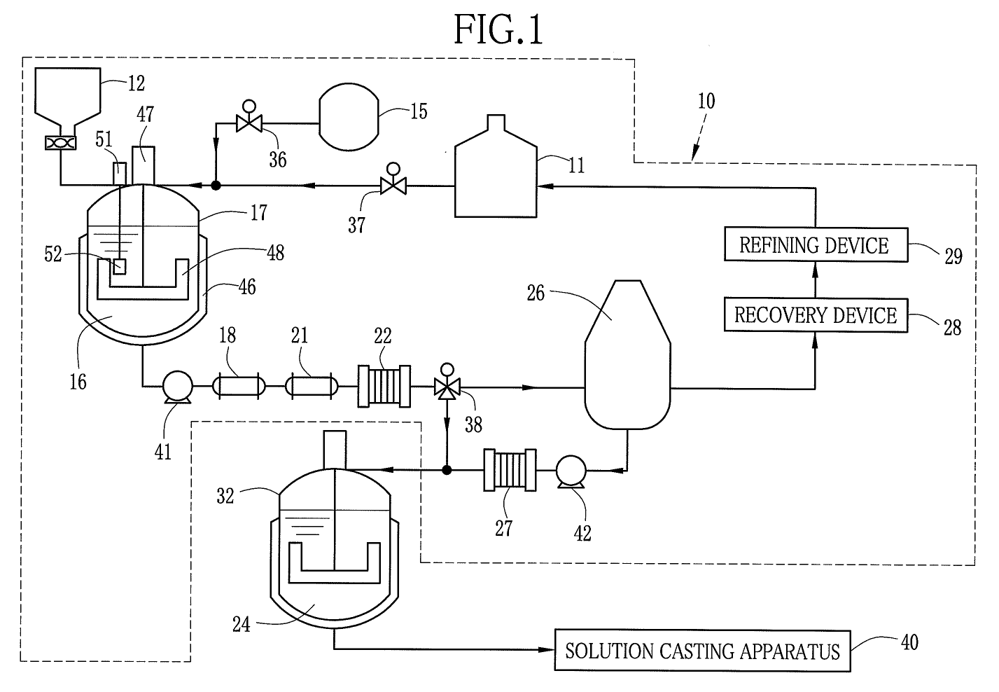

In FIG. 1, a dope producing apparatus 10 is provided with a solvent tank 11, a hopper 12, an additive tank 15, a mixing tank 17, a heater 18, a temperature controller 21, a filtration device 22, a flash device 26, and a filtration device 27. The solvent tank 11 stores a solvent. The hopper 12 supplies the cellulose acylate. The additive tank 15 stores an additive. In the mixing tank 17, the solvent, the cellulose acylate, and the additive are mixed to make a mixture 16 which is in the liquid state. The heater 18 heats the mixture 16. The temperature controller 21 adjusts temperature of the heated mixture 16. The mixture 16 sent from the temperature controller 21 is filtered through the filtration device 22. The flash device 26 adjusts concentration of a dope 24. Thereafter, the dope 24 is filtered through the filtration device 27. The dope producing apparatus 10 is further provided with a recovery device 28 and a refining device 29. The recovery device 28 recovers the solvent. The refining device 29 refines the recovered solvent. The dope producing apparatus 10 is connected to a solution casting apparatus 40 via a stock tank 32. Valves 36 to 38 and pumps 41 and 42 are provided in the dope producing apparatus 10. The valves 36 to 38 adjust liquid flow amounts. The pumps 41 and 42 feed liquids. The positions of the valves 36 to 38 and the pumps 41 and 42, and the number of the pumps may be changed as necessary.

The dope 24 is produced by the following method using the dope producing apparatus 10. By opening the valve 37, the solvent is fed from the solvent tank 11 to the mixing tank 17. Next, the cellulose acylate is fed from the hopper 12 to the mixing tank 17. Cellulose acylate may be continuously fed to the mixing tank 17 using a feeding device (not shown) which continuously measures the amount of the cellulose acylate while feeding it. Alternatively, the cellulose acylate may be intermittently fed to the mixing tank 17 using a feeding device (not shown) which feeds a predetermined amount of the cellulose acylate after the amount of the cellulose acylate is measured. By opening and closing the valve 36, a necessary amount of the additive solution is fed from the additive tank 15 to the mixing tank 17.

The additive may be fed in the state of a solution. In the case the additive is in the liquid state at room temperature, the additive may be fed to the mixing tank 17 in the liquid state. In the case the additive is in the solid state, the additive may be fed to the mixing tank 17 using a hopper or the like. In the case a plurality of additives are added, a solution in which the additives are dissolved may be put in the additive tank 15. Alternatively, a plurality of additive tanks may be used. In this case, each additive tank contains a solution in which an additive is dissolved. Each additive tank is connected to the mixing tank 17 through an independent pipe to feed the solution.

As described above, the solvents, the cellulose acylate, and the additives are put in the mixing tank 17 in this order. However, the order is not limited. The additive is not necessarily mixed to the cellulose acylate and the solvent in the mixing tank 17. The additive may be mixed to a mixture of the cellulose acylate and the solvent by an inline mixing method in a subsequent process.

It is preferable that the mixing tank 17 is provided with a jacket 46, a first stirrer 48, and a second stirrer 52. The jacket 46 covers an outer surface of the mixing tank 17. A heat transfer medium is supplied to a space between the jacket 46 and the mixing tank 17. The first stirrer 48 is rotated by a motor 47. The second stirrer 52 is rotated by a motor 51. The temperature of the mixing tank 17 is adjusted by the heat transfer medium, and a preferable temperature range is −10° C. to 55° C. The first stirrer 48 and the second stirrer 52 are selectively used for stirring the solvent, the cellulose acylate and the additive. Thus, the mixture 16 in which the cellulose acylate is swelled by the solvent is obtained. It is preferable that the first stirrer 48 has an anchor blade, and the second stirrer 52 is an eccentric stirrer of a dissolver type.

Next, the mixture 16 is fed to the heater 18 using the pump 41. It is preferable that the heater 18 is a pipe (not shown) with a jacket. A heat transfer medium is passed between the pipe and the jacket. In addition, it is preferable that the heater 18 has a pressurizing section (not shown) to pressurize the mixture 16. With the use of the heater 18, solid contents in the mixture 16 are effectively and efficiently dissolved under a heated condition, or a pressurized and heated condition. Hereinafter, a method in which the solid contents are dissolved in the solvent by heating is referred to as a heat-dissolving method. In the heat-dissolving method, it is preferable to heat the mixture 16 to a temperature in a range of 0° C. to 97° C.

Alternatively, a cool-dissolving method may be used. In the cool-dissolving method, dissolution of the solid contents is enhanced while the mixture 16 is kept at a predetermined temperature, or cooled to a low temperature. In the cool-dissolving method, it is preferable to cool the mixture 16 to a temperature in a range of −100° C. to −10° C. With the use of the above heat-dissolving method or the cool-dissolving method, the cellulose acylate is sufficiently dissolved in the solvent.

After the temperature of the mixture 16 is adjusted at approximate room temperature using the temperature controller 21, the mixture 16 is filtered through the filtration device 22 to remove foreign substances such as impurities and aggregations. Hereinafter, the mixture 16 is referred to as the dope 24. An average pore diameter of the filter used in the filtration device 22 is preferably not more than 100 μm. It is preferable that a filtration flow volume is not less than 50 liter/hr.

After the filtration, the dope 24 is fed to the stock tank 32 through the valve 38, and temporarily stored. Thereafter, the dope 24 is used for the film production.

As described above, the method in which the solid contents are swelled and then dissolved to make the solution needs longer time for preparing the dope, especially when the concentration of the cellulose acylate in the solution is increased. Such method has a problem in production efficiency. In this case, it is preferable to prepare a dope having a lower concentration than that required, and then concentrate the dope to achieve the required concentration. For example, the dope 24 is fed to the flash device 26 after the filtration through the filtration device 22, and a part of the solvent of the dope 24 is evaporated for concentration. The concentrated dope 24 is taken out of the flash device 26 through the pump 42 and fed to the filtration device 27. It is preferable that the temperature of the dope 24 is in a range 0° C. to 200° C. at the time of filtration. The dope 24 from which foreign substances are removed through the filtration device 27 is fed to the stock tank 32 and temporarily stored therein. Thereafter, the dope 24 is used for the film production. The concentrated dope 24 may contain foam. If so, it is preferable to perform defoaming before the dope 24 is fed to the filtration device 27. Various known defoaming methods may be used, for example, a method to radiate ultrasound to the dope 24.

The solvent vapors generated by flash evaporation in the flash device 26 are condensed in the recovery device 28 having a condenser (not shown). Thereby, the solvent vapors are condensed into a liquid and recovered. The recovered solvent is refined as a solvent in the refining device 29, and reused in the dope production. Such recovering and refining of the solvent vapors are advantageous in reducing production cost. In addition, since recovering and refining are performed in a closed system, adverse effects to humans and the environment are prevented.

Thus, the dope 24 having the cellulose acylate concentration of 5 wt % to 40 wt % is produced. It is more preferable that the cellulose acylate concentration is not less than 15 wt. % and not more than 30 wt. %. It is furthermore preferable that the cellulose acylate concentration is not less than 17 wt. % and not more than 25 wt. %. It is preferable that the additive concentration is not less than 1 wt. % and not more than 20 wt. % with respect to a total solid content.

Materials, raw materials, and dissolving methods of additives, filtration methods, defoaming, and adding methods are detailed in paragraphs [0517] to [0616] of Japanese Patent Laid-Open Publication No. 2005-104148. The above descriptions may also be applied to the present invention.

[Apparatus and Method for Producing Film]

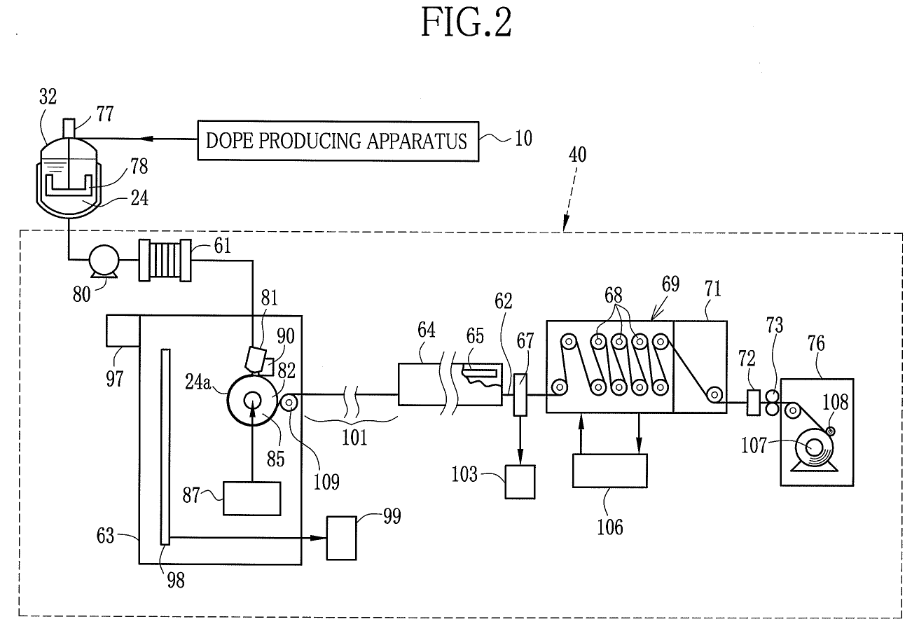

In FIG. 2, the solution casting apparatus 40 has a filtration device 61, a casting chamber 63, a tenter 64, an edge slitting device 67, a drying chamber 69, a cooling chamber 71, a neutralization device 72, a pair of knurling rollers 73, and a winding chamber 76. The filtration device 61 removes foreign substances from the dope 24 fed from the stock tank 32. In the casting chamber 63, the dope 24 filtered through the filtration device 61 is cast and a cellulose acylate film (hereinafter referred to as a film) 62 is formed. In the tenter 64, the film 62 is dried while being conveyed in a state that side edge portions are held. The both side edge portions of the film 62 are cut off in the edge slitting device 67. In the drying chamber 69, the film 62 is bridged across a plurality of rollers 68 and dried while being conveyed. The film 62 is cooled in the cooling chamber 71. An amount of charged voltage of the film 62 is reduced in the neutralization device 72. Embossing processing is performed to the both side edge portions of the film 62 using the pair of knurling rollers 73. The film 62 is wound in the winding chamber 76.

A stirrer 78 is attached to the stock tank 32. The stirrer 78 is rotated by a motor 77. The dope 24 is stirred by the rotation of the stirrer 78. Thereafter, the dope 24 in the stock tank 32 is fed to the filtration device 61 through a pump 80.

The casting chamber 63 is provided with a casting die 81 and a drum 82 for casting. The dope 24 is cast through the casting die 81 onto an outer peripheral surface (hereinafter referred to as casting surface) of the rotating drum 82, which is the support.

A width of the casting die 81 is not particularly limited. However, it is preferable that the width of the casting die 81 is in a range of 1.1 times to 2.0 times larger than the width of the film 62 as an end product. To maintain the temperature of the dope 24 at a predetermined value during the film production, it is preferable to install a temperature controller (not shown) to the casting die 81 for controlling the temperature of the casting die 81. In addition, it is preferable that the casting die 81 is provided with bolts (heat bolts) which adjust the size of the slit of the casting die 81 so as to adjust the thickness of a casting bead discharged from the casting die 81. The casting bead is the dope 24 between the casting die 81 and the drum 82. It is preferable that the heat bolts are provided at predetermined intervals in the width direction of the slit. It is also preferable that the heat bolts are controlled by an automatic thickness adjusting mechanism. It is preferable to set the profile of the slit according to the flow volume of the pump 80 based on the previously set program. It is preferable that the pump 80 is a high-precision gear pump so as to precisely control the flow volume of the dope 24. It is also possible to provide a thickness measuring device such as an infrared thickness gauge in the solution casting apparatus 40. In this case, the feedback control of the automatic thickness adjusting mechanism is performed based on the adjusting program according to the thickness profile of the film 62 and the detection results of the thickness measuring device. The casting die 81 is capable of adjusting the slit of the lip end by ±50 μm such that a difference in thicknesses between two given points on the film 62 as the end product is preferably adjusted within 1 μm except for its side edge portions.

The dope 24 may be partially dried and become solid at the lip ends of the casting die 81. In order to prevent such solidification of the dope 24, a liquid supplying device (not shown) is installed in the proximity of the lip ends for supplying a liquid to the lip ends. It is preferable that the liquid is supplied in the proximity of three-phase contact lines where the casting bead, the lip end and air meet. It is preferable that the flow volume of the liquid supplied to each side edge of the slit of the casting die 81 is in a range of 0.1 ml/min to 1.0 ml/min. The liquid which is compatible with the dope 24 or solubilizes the dope 24 may be used. The liquid may have the same formulation as the solvent of the dope 24. Thereby, contamination of the casting film 24a with foreign substances such as solid contents precipitated from the dope 24 and substances mixed into the casting bead are prevented. It is preferable to use the pump with a pulsation of 5% or less for supplying the liquid.

The drum 82 placed below the casting die 81 is rotated by a driving device (not shown). The width of the casting surface of the drum 82 is not particularly limited. However, it is preferable that the width of the casting surface is in a range of 1.1 times to 2.0 times larger than the casting width of the dope 24.

The drum 82 is provided with a heat transfer medium circulation device 87. The heat transfer medium circulation device 87 supplies a heat transfer medium inside the drum 82 to control the temperature of the casting surface of the drum 82. A flow path (not shown) of the heat transfer medium is formed inside the drum 82. The temperature of the casting surface is kept at a predetermined value by passing the heat transfer medium kept at a predetermined temperature through the flow path. The temperature of the casting surface is set at an appropriate value in accordance with a kind of the solvent, kinds of solid contents, a concentration of the dope 24 and the like.

Instead of using the drum 82, a belt (not shown) may be used as a support. The belt is supported and rotated by rotation rollers (not shown). In the case the drum 82 is used, it is preferable that the drum 82 is rotated with high precision such that not more than 0.2% of the rotation speed is permitted as rotation speed variation. The surface roughness of the drum 82 is preferably not more than 0.01 μm. It is preferable that the casting surface of the drum 82 is chrome plated. Thereby, sufficient hardness is provided and durability is improved. The casting surface of the drum 82 is preferably defect-free. To be more specific, the number of pin holes whose diameter is more than 30 μm is preferably zero. The number of pinholes whose diameter is not less than 10 μm and less than 30 μm is preferably 1 or less per 1 m². The number of pinholes whose diameter is less than 10 μm is 2 or less per 1 m².

A decompression chamber 90 is provided in the proximity of the casting die 81. The decompression chamber 90 sucks air from an area upstream from the casting bead with respect to the rotation direction of the drum 82 to reduce the pressure.

The casting chamber 63 is provided with a temperature controller 97 and a condenser 98. The temperature controller 97 keeps the inner temperature of the casting chamber 63 at a predetermined value. The condenser 98 condenses and recovers solvent vapors evaporated from the dope 24 and the casting film 24a. A recovery device 99 is provided outside the casting chamber 63. The recovery device 99 recovers the condensed and liquefied solvent.

An air blower (not shown) may be provided to a transfer section 101. The transfer section 101 is a section between the casting chamber 63 and the tenter 64. A crusher 103 is provided in the edge slitting device 67. The crusher 103 crushes the cut-off side edge portions of the film 62 into chips.

A recovery device 106 of adsorbing type is attached to the drying chamber 69. The recovery device 106 adsorbs and recovers solvent vapors evaporated from the film 62. The cooling chamber 71 is provided at the downstream from the drying chamber 69. A moisture control chamber (not shown) may be provided between the drying chamber 69 and the cooling chamber 71 so as to adjust a water content of the film 62. The neutralization device 72 is a so-called compulsory neutralization device such as a neutralization bar and the like, and adjusts the charged voltage of the film 62 within a predetermined range. The installation position of the neutralization device 72 is not limited to the downstream side from the cooling chamber 71. The pair of knurling rollers 73 provides knurling to the both side edge portions of the film 62 by embossing processing. A winding shaft 107 and a press roller 108 are provided in the winding chamber 76. The winding shaft 107 winds the film 62. The tension of winding is controlled by the press roller 108.

Next, an example of a method for producing the film 62 using the solution casting apparatus 40 is described in the following. The dope 24 is fed to the stock tank 32, and made constantly uniform by the rotation of the stirrer 78. Thereby, precipitation and coagulation of the solid content of the dope 24 are prevented until the casting. Various additives may be mixed with an appropriate amount during the stirring of the dope 24. The foreign substances larger than a predetermined particle diameter and those in a gel state are removed from the dope 24 through filtration of the filtration device 61.

After the filtration, the dope 24 is cast from the casting die 81 onto the drum 82 cooled by the heat transfer medium. It is preferable that the temperature of the dope 24 at the time of casting is constant in a range of 30° C. to 35° C. It is preferable that the temperature of the casting surface of the drum 82 is constant in a range of −10° C. to 10° C. The temperature of the casting chamber 63 is controlled by the temperature controller 97 in a range of 10° C. to 30° C. The solvent vapors evaporated inside the casting chamber 63 are recovered by the recovery device 99. Thereafter, the recovered solvent is refined and recycled as the solvent for use in the dope preparation.

The casting bead is the dope 24 between the casting die 81 and the drum 82. On the casting surface of the drum 82, the casting film 24a is formed. To stabilize the condition of the casting bead, a pressure in the area upstream from the casting bead is controlled to achieve a predetermined value using the decompression chamber 90. It is preferable to adjust the pressure in the upstream area of the casting bead to be lower than that in the downstream area by 2000 Pa to 10 Pa. It is preferable to attach a jacket (not shown) to the decompression chamber 90 to keep the inner temperature thereof at a constant value. The temperature is preferably equal to or above the condensation point of the solvent of the dope. In order to keep the casting bead in a desired shape, it is preferable to install an edge suction device (not shown) to the side edge portions of the casting die 81. The edge suction device sucks air from areas in the proximity of the side edge portions of the casting bead. The air suction volume is preferably in a range of 1 liter/min to 100 liter/min.

The casting film 24a is cooled and becomes a gel state and solidified by the drum 82. Upon obtaining the self supporting property, the casting film 24a is peeled off from the drum 82 while being supported by a peel roller 109. The casting film 24a is peeled off from the drum 82 when the casting film 24a obtains sufficient hardness for conveying, regardless of the residual solvent content. In view of production efficiency, it is preferable to cool the casting film 24a to achieve sufficient hardness even when the residual solvent content is high. When the exposed surfaces of the casting film 24a are sufficiently hardened by cooling, dry air may be supplied in the proximity of the casting film 24a so as to improve stability of the casting film 24a during conveyance after the casting film 24a is peeled off. In order to achieve a high production speed such as 50 m/min, it is preferable to cool the casting film 24a quickly so that the casting film 24a is sufficiently hardened for peeling even when the residual solvent content is more than 250%. In the case the temperature of the drum 82 cannot be set at a lower value, it may be necessary to upsize the drum 82 instead of the quick cooling of the casting film 24a. In the case the residual solvent content is higher than 300%, it is difficult to harden the casting film 24a to sufficient hardness for conveying even if the casting film 24a is cooled. Accordingly, the solvent contained in the casting film 24a at the time of peeling the casting film 24a is preferably not less than 250% and not more than 300% when the weight of the solid content is 100%. In other words, in the present invention, the residual solvent content (unit: %) is a value on dry basis. To be more specific, the residual solvent content is calculated by a mathematical formula {x/(y−x)}×100 where x is a weight of the solvent and y is a weight of the casting film 24a. Hereinafter, the residual solvent rate at the time of peeling is referred to as W.

A wet film, namely, the film 62 containing the solvent is fed to the tenter 64. In the tenter 64, the side edge portions of the film 62 are pierced and held by pins and conveyed in accordance with the movements of the pins. While being conveyed through the tenter 64, the film 62 is dried by dry air supplied from an air duct 65 provided in the tenter 64.

After the film 62 is dried in the tenter 64 and the residual solvent content reaches a predetermined value, the both side edge portions of the film 62 are cut off by the edge slitting device 67. The cut-off side edge portions are sent to the crusher 103 using a cutter blower (not shown). The crusher 103 crushes the cut-off side edge portions into chips. The chips are reused for the dope production, and thus the raw material is effectively used. The process of cutting the both side edge portions of the film 62 may be omitted. However, it is preferable to perform this cutting process between the dope casting process and the film winding process.

After the both side edge portions are cut off, the film 62 is sent to the drying chamber 69 and further dried. In the drying chamber 69, the film 62 is bridged across the rollers 68 and conveyed. The inner temperature of the drying chamber 69 is not particularly limited. However, it is preferable that the inner temperature is set at a value in a range of 50° C. to 160° C. It is preferable to divide the drying chamber 69 into plural sections in the conveying direction of the film 62 so as to change the temperature of air supplied to each section. In addition, it is preferable to provide a predrying chamber (not shown) between the edge slitting device 67 and the drying chamber 69 to predry the film 62. Thereby, changes in shapes and conditions of the film 62 caused by abrupt increase of the film temperature is prevented in the drying chamber 69. The solvent vapors evaporated in the drying chamber 69 is adsorbed and recovered by the recovery device 106. After the solvent content is removed, air is supplied to the drying chamber 69 as dry air.

The film 62 is cooled to the approximate room temperature in the cooling chamber 71. In the case the moisture control chamber is provided between the drying chamber 69 and the cooling chamber 71, it is preferable to blow air at a predetermined temperature and humidity to the film 62 in the moisture control chamber. Thereby, curling and winding defects of the film 62 are prevented.

In the solution casting method, there are various processes, for example, the drying process and the process of cutting the both side edge portions of the film 62, between the peeling off of the film 62 from the support and the winding of the film 62. In each process, or between the processes, the film 62 is mainly supported or conveyed by the rollers. There are driving rollers and non-driving rollers. The non-driving rollers determine the conveying path of the film 62 and improve stability in conveyance.

The neutralization device 72 sets the charged voltage of the film 62 at a predetermined value during conveyance. It is preferable that the charged voltage after neutralization has a value in a range of −3 kV to +3 kV. In addition, knurling was provided, by the pair of knurling rollers 73, to both side edge portions of the film 62. It is preferable that a height of the knurling has a value in a range of 1 μm to 200 μm.

The film 62 is wound by the winding shaft 107 in the winding chamber 76. It is preferable to wind the film 62 while predetermined tension is applied to the film 62 by the press roller 108. It is preferable to gradually change the tension from the start to the end of winding, which prevents excessive tightening of the film roll. It is preferable that a length of the film 62 to be wound is not less than 100 m. It is preferable that the width of the film 62 is not less than 600 mm and in a range of 1400 mm to 2500 mm. However, the present invention is also applicable to films having the width larger than 2500 mm. In addition, the present invention is also applicable to production of thin films with the thickness of 15 μm to 100 μm.

In the present invention, two or more kinds of dopes may be simultaneously co-cast by a simultaneous co-casting method, or sequentially co-cast by a sequential co-casting method. When the simultaneous co-casting is performed, a casting die with a feed block or a casting die of a multi-manifold type may be used. A thickness of at least one of surface layers, which are exposed to air, of a multilayer film produced by co-casting preferably constitute 0.5% to 30% of the total thickness of the multilayer film. In the co-casting method, it is preferable to adjust concentration of each dope such that the lower viscosity dopes may entirely cover over the higher viscosity dope when the dope is cast onto the support from a die slit. Furthermore, with regard to the casting bead formed between the die slit and the support in the simultaneous co-casing method, it is preferable that an outer dope (outer casting bead) exposed to air contains a higher ratio of a poor solvent than inner dopes (inner casting beads).

Paragraphs from [0617] to [0889] of Japanese Patent Laid-Open Publication No. 2005-104148 describe in detail the structures of the casting die, the decompression chamber and the support, co-casting, peeling methods, stretching, drying condition in each process, a handling method, curling, a winding method after the correction of planarity, a recovering method of the solvent, and a recovering method of film. The above descriptions may be applied to the present invention.

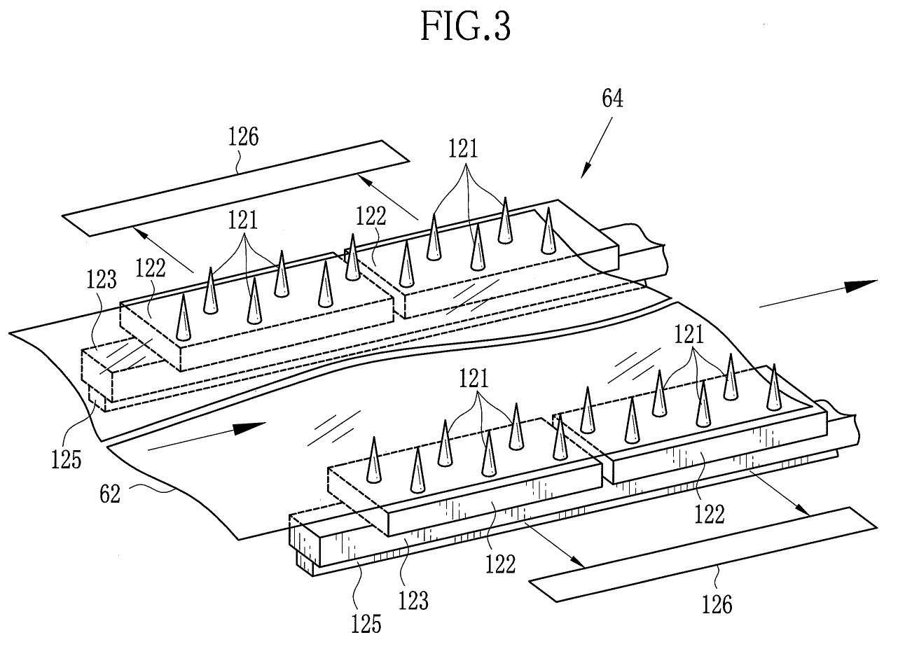

In FIG. 3, pin plates 122, chains 123, rails 125, and a drying device (see numeral 65 in FIG. 2) are provided inside the tenter 64. The pin plates 122, the chain 123, and the rail 125 are placed in the close proximity of each of the side edge portions of the film 62 along the conveying path of the film 62. Each pin plate 122 has a plurality of pins 121. A plurality of the pin plates 122 are attached to each chain 123. The chain 123 is an endless chain which moves continuously. Each chain 123 is guided by the rail 125. Each rail 125 has a shifting mechanism 126. When the film 62 reaches a predetermined position in the tenter 64, the side edge portions of the film 62 are pierced and held by the pins 121. The shifting mechanisms 126 shift the rails 125 in the width direction of the film 62, and the chains 123 move along the rails 125. In accordance with the movements of the chains 123, the pin plates 122 attached to the chains 123 move in the width direction of the film 62 while holding the film 62. Thus, tension is applied to the film 62 in the width direction.

Immediately after being peeled off from the drum 82, the film 62 contains a large amount of the solvent and extremely unstable. As a result, it is difficult to convey the film 62 using rollers. In addition, such film 62 cannot be held by clips. For that reason, the side edge portions of the film 62 are pierced and held by the pins 121. Thus, the film 62 is conveyed stably.

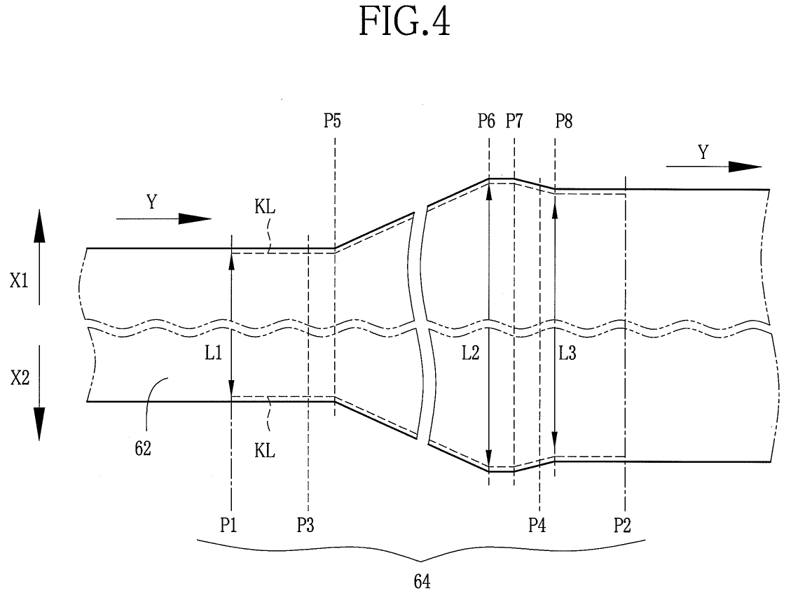

In FIG. 4, an arrow Y is a conveying direction of the film 62. In the tenter 64, a first position P1 is a position where the pins 121 start to hold the film 62, and a second position P2 is a position where the film 62 is released from the pins 121. An inlet of the tenter 64 is located upstream from the first position P1. An outlet of the tenter 64 is located downstream from the second position P2. The inlet and the outlet are not shown in FIG. 4.

The solvent gradually evaporates from the film 62 peeled off from the drum 82. When a residual solvent content in the film 62 at the time of peeling is represented by a residual solvent content W, the residual solvent content is reduced from the residual solvent content W with time. A position where the residual solvent content reaches (W−5) % is defined as a third position P3. A position where the residual solvent content reaches 50% is defined as a fourth position P4.

In the tenter 64, the tension is applied to the film 62 in a width direction shown by arrows X1 and X2, and a first drying step and a second drying step are performed. In the first drying step, the film 62 is stretched in the width direction using the pins and dried by dry air. Thereafter, in the second drying step, the film 62 is dried while the film 62 is held by the pins and the tension is applied to the film 62 in the width direction. Without applying the tension in the width direction, the film 62 is loosened due to the self weight or shrinks in the width direction in accordance with evaporation of the solvent. In the present invention, in order to produce the film 62 in which humidity dependence of an in-plane retardation Re is reduced and to prevent loosening of the film 62, the tension is applied to the film 62 in the width directions X1 and X2. It is preferable to apply the tension to the film 62 symmetrically with respect to a center in the width direction of the film 62. This helps to uniformly control molecular orientation in the width direction.

A width of the film 62 at the inlet of the tenter L1 is defined as a first width L1. With the application of the tension, the first width L1 is increased to a second width L2. The second width L2 may be kept unchanged in subsequent processes. However, it is more preferable to reduce the second width L2. In this case, a reduced width is referred to as a third width L3. In either case, the tension is applied to the film 62 in the width directions X1 and X2. To reduce the width of the film 62, a shrinking force of the film 62 is utilized. That is, the film 62 shrinks naturally when the film 62 is not held by the pins. The width of the film 62 is controlled by adjusting the balance between the shrinking force and the tension applied to the film 62 by the pins. Hereinafter, stretching refers to the increase of the width of the film 62, and contraction refers to the reduction of the width of the film 62. In FIG. 4, imaginary lines KL denote the innermost positions with respect to the width direction of the side edge portions of the film 62 which are pierced and held by the pins 121. The first to the third widths L1 to L3 denote distances between the opposing film holding lines KL.

A fifth position P5 is a position where a stretching from the first width L1 to the second width L2 is started. A sixth position P6 is a position where the stretching is ended. A seventh position P7 is a position where the contraction from the second width L2 to the third width L3 is started. An eighth position P8 is a position where the contraction is ended. It is preferable that the drying of the film 62 is advanced while the film 62 is stretched in the width direction, and it is preferable that the stretching is ended before the residual solvent content reaches 50%. Namely, it is preferable that the sixth position P6 is the same as or in the upstream of the fourth position P4. The start timing of the stretching is not particularly limited. However, it is preferable that the fifth position P5 is the same as or in the downstream from the third position P3.

In the present invention, it is preferable that a stretch ratio of the film 62 between the fifth position P5 and the sixth position P6 is not less than 5% and not more than 30%. The stretch ratio (unit: %) is calculated by a mathematical expression {(L2−L1)/L1}×100. The stretching is performed at the above stretch ratio and ended while the residual solvent content is extremely high, namely, before the residual solvent content reaches 50%. Thereby, the effect of producing the film 62 having the retardation Re of low humidity dependence is improved. This is achieved by making the molecules oriented in the width direction between the fifth position P5 and the sixth position P6. In processes after the tenter 64, tension is applied to the film 62 in the conveying direction Y during conveyance. Therefore, it is difficult to prevent molecular orientation of the film 62 in the conveying direction Y. However, with the use of the above method, the molecular orientation of the film 62 in the conveying direction Y and that in the width direction X1-X2 are balanced. Thus, increase of humidity dependence of the retardation Re is more effectively prevented. This effect is also achieved in off-line stretching. In the off-line stretching, a long film is temporarily wound in a roll form, and then the long film is fed from the roll and stretched in the width direction. Namely, in producing the long film which is to be stretched later in the width direction, the off-line stretching in the width direction achieves the balance between the molecular orientation in the conveying direction and the molecular orientation in the width direction, even if the film has a high molecular orientation in the conveying direction at the time of the first drying step, and thus the humidity dependence of the Re is reduced.

When the stretching is started after the residual solvent content is less than 50%, the above effect may be reduced. When the stretch ratio is more than 30%, molecular orientation in the width direction X1-X2 may be too large, or the film 62 may be torn along the film holding lines KL. Accordingly, the stretch ratio is determined in consideration of the thickness, elasticity, and the like of the film 62.

After the above first drying step, the second drying step is performed while the side edge portions of the film 62 are continuously held from the first drying step. It is preferable to keep the width or perform contraction by applying the tension to the film 62. The second drying step may be performed regardless of the residual solvent content as long as the second drying step is performed after the first drying step. For example, the first drying step may be ended when the residual solvent content is higher than 50% and then the second drying step may be performed while the residual solvent content remains higher than 50%. Accordingly, the seventh position P7 is the same as or in the downstream from the sixth position P6 regardless of the fourth position P4. The contraction may be ended at any point before the film 62 reaches the eighth position P8.

It is preferable that a contraction ratio of the contraction in the second drying step is at most 10%. In the present invention, the second width L2 may be kept unchanged without the contraction. Accordingly, the contraction ratio is in a range of zero to 10%. The contraction after the stretching improves molecular orientation conditions in view of humidity dependence of the retardation Re. When the contraction ratio is more than 10%, the effect of the stretching performed prior to the contraction may be reduced. The contraction ratio is calculated by a mathematical expression {(L2−L3)/L3}×100.

If the humidity dependence of the retardation Re is sufficiently reduced in the first drying step, stretching may be performed after the residual solvent amount reaches 10 wt. % regardless of whether the width of the film 62 is reduced or kept in the second drying step. In this case, the stretching of the film 62 makes the surface of the film 62 smooth. It is preferable that the stretch ratio calculated by 100×(LA−LB)/LA (unit: %) is more than zero but not more than 5% when LB denotes the width of the film 62 before the stretching and LA denotes the width after the stretching.

A “first ratio” is defined as a value calculated by (a moving speed (unit: m/min) of the pin plate 122 which conveys the film 62 by holding the film 62 with the pins 121)/(a rotation speed of the drum (m/min)). The moving speed of the pin plate 122 is a moving speed of the film 62 in the tenter 64. The rotation speed of the drum is a rotation speed of the casting surface of the drum and equivalent to a moving speed of the casting film 24a. A “second ratio” is defined as a value calculated by L2/L1. A “third ratio” is defined as a value calculated by L3/L2. The first, the second, and the third ratios satisfy 0.94≦(the first ratio)/{(the second ratio)·(the third ratio)}≦0.97. The rotation speed of the drum and the moving speed of the pin plate are adjusted and the stretch ratios of the film 62 in the first and the second drying steps are determined to satisfy the above conditions.

Even if the stretch ratio is less than 5% in the first drying step, the film having the retardation value of lower humidity dependence may be produced. In this case, after the initial stretching, contraction of the film 62 is performed in the tenter 64, and then the film 62 is stretched in the width direction with the use of a clip tenter in the subsequent process. As well known, the clip tenter holds side edge portions of the film by clips and applies tension to the film in the width direction by moving the clips in the width direction of the film. The clip tenter may be installed between the pin tenter and the winding chamber 76. It is also possible to unwind the film 62 which has been wound in the roll form in the winding chamber 76, and apply the tension to the film 62 by the clip tenter.

[Characteristics and Measuring Method]

(Curling and Thickness)

The characteristics of the wound film 62 and measuring methods of the characteristics are detailed in paragraphs from [0112] to [0139] of Japanese Patent Laid-Open Publication 2005-104148. These descriptions may be applied to the present invention.

(Applications)

The cellulose acylate films are especially effective for use in protection films for polarizing filters. The polarizing filter is produced by adhering the cellulose acylate film to a polarizer. In general, the LCD device has a structure in which a liquid crystal layer is sandwiched by two polarizing filters. However, the arrangement of the liquid crystal layer and polarizing filters is not limited to the above, and any known arrangements may be used. For example, the Japanese Patent Laid-Open Publication No. 2005-104148 discloses TN type, STN type, VA type, OCB type, reflection type, and other types of the LCD devices in detail. Such LCD devices may be applied to the present invention. The above publication teaches the cellulose acylate film provided with an optical anisotropic layer and that provided with antireflective and antiglare functions. Furthermore, the above publication discloses a biaxial cellulose acylate film which is a cellulose acylate film to which appropriate optical functions are imparted. The biaxial cellulose acylate film may also be used as an optical compensation film. The above described film may also serve as the protective films in the polarizing filter. Paragraphs from [1088] to [1265] in the Japanese Patent Laid-Open Publication No. 2005-104148 describe the above in detail.

In addition, the produced film is used as an optical compensation film which improves viewing angle dependence of the LCD device for use in a television and the like. Accordingly, the produced film is used in IPS mode, OCB mode, VA mode, and the like in addition to the conventional TN mode.

### EXAMPLE

The dope 24 having the following composition was produced using the dope production apparatus 10.

| | |
|---|---|
| Cellulose triacetate (TAC) | 100 pts. wt. |
| (degree of substitution: 2.94, viscometric average | |
| degree of polymerization: 305.6%, viscosity of 6 wt. % | |
| of dichloromethane solution: 350 mPa · s) | |
| Dichloromethane (first component of the solvent) | 390 pts. wt. |
| Methanol (second component of the solvent) | 60 pts. wt. |
| Retardation reducing agent shown in Chemical formula 1 | 12 pts. wt. |
| Chromatic dispersion controller shown in Chemical | 1.8 pts. wt. |
| formula 2 | |
| Citric acid ester mixture (a mixture of citric acid, citric | 0.006 pts. wt. |
| acid monoethyl ester, citric acid diethyl ester and | |
| citric acid triethyl ester) | |
| Fineparticles (silicon dioxide, average particle | 0.05 pts. wt. |
| diameter: 15 nm, Mohs hardness: approximately 7) | |

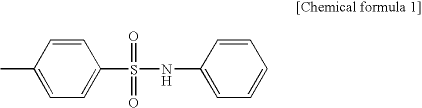

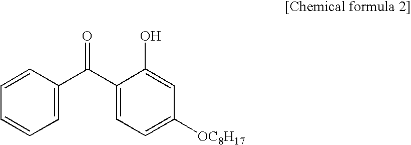

Plural films 62 were produced from the above dope 24 using the solution casting apparatus 40. Production conditions are shown in Tables 1-1 and 1-2. The present invention corresponds to the experiments 1 to 3. Comparative experiments to the present invention are described in comparative experiments 1 to 6. In the experiment 3, a retardation increasing agent was added in addition to the above components. This retardation increasing agent was the one used for a film for use in the LCD of VA type. An in-plane retardation Re of the retardation increasing agent was 55 nm. A retardation Rth in the thickness direction of the retardation increasing agent was 200 nm. Results of the experiments 1 to 3 are shown in the Table 1-1. Results of the comparative experiments 1 to 6 and the reference experiments 1 and 2 are shown in the Table 1-2. In the top row of the Tables 1-1 and 1-2, E1 to E3 denote the experiments 1 to 3, and C1 to C6 denote the comparative experiments 1 to 6, and R1 and R2 denote the reference experiments 1 and 2. The numbers on the leftmost column of the Tables 1-1 and 1-2 denote the following.
1: film production speed (unit: m/min).
2: thickness of the film 62 to be produced (unit: μm).
3: residual solvent content W at the time of peeling the casting film 24a(unit: wt %).
4: first ratio, calculated by (moving speed (m/min) of the pin plate 122/(rotation speed(m/min) of the drum).
5: residual solvent content of the film 62 at the fifth position P5 (unit: wt %).
6: residual solvent content of the film 62 at the sixth position P6 (unit: wt %).
7: 100×(L2−L1)/L1 (unit: %) which is the stretch ratio in the first drying step as described above.
8: 100×(L2−L3)/L3 (unit: %) which is the contraction ratio of the contraction in the second drying step.
9: stretch ratio (unit: %) in the off-line when the film 62 produced in the solution casting apparatus 40 is fed from the winding shaft 107 and the width of the film 62 is further stretched in the clip tenter (not shown), that is, a percentage calculated by L5/L4, when L4 denotes the width of the film 62 before the stretching in the clip tenter and L5 denotes the width after the stretching. In the experiments 1 to 3 and the comparative experiments 1 to 6, the stretching was not performed off-line, which is indicated by “-” in the Tables 1-1 and 1-2.
10: (the first ratio)/(the second ratio)·(the third ratio)
11: ΔRe representing humidity dependence of the retardation Re (unit: %). ΔRe is obtained by taking a sample from the film 62 wound in the winding chamber 76 and examining the humidity dependence of the sample film. Each value in this row is calculated by subtracting the retardation Re at 25° C., 80% RH from that at 25° C., 10% RH. The humidity dependence of the retardation Re reduces as the value ΔRe reduces. The smaller ΔRe is more preferable.

TABLE 1-1

| | E1 | E2 | E3 |
|---|---|---|---|
| 1 | 30 | 80 | 80 |
| 2 | 60 | 60 | 60 |
| 3 | 250 | 270 | 270 |
| 4 | 1.02 | 1.10 | 1.10 |
| 5 | 240 | 260 | 260 |
| 6 | 80 | 50 | 50 |
| 7 | 6 | 14 | 22 |
| 8 | 0 | 0 | 8 |
| 9 | — | — | — |
| 10 | 0.96 | 0.96 | 0.96 |
| 11 | 0.5 | 0.5 | 0.5 |

TABLE 1-2

| | C1 | C2 | C3 | C4 | C5 | C6 | R1 | R2 |
|---|---|---|---|---|---|---|---|---|
| 1 | 80 | 30 | 80 | 80 | 100 | 30 | 80 | 50 |
| 2 | 60 | 60 | 60 | 60 | 60 | 60 | 60 | 105 |
| 3 | 270 | 250 | 270 | 270 | 270 | 250 | 270 | 280 |
| 4 | 1.10 | 1.01 | 1.10 | 1.10 | 1.18 | 1.01 | 1.10 | 1.04 |
| 5 | 40 | 40 | 260 | 260 | 260 | 260 | 260 | 270 |
| 6 | 10 | 10 | 50 | 50 | 50 | 50 | 50 | 180 |
| 7 | 14 | 5 | 12 | 25 | 35 | 3 | 5 | 7 |
| 8 | 0 | 0 | 0 | 11 | 8 | 0 | 7 | 0 |
| 9 | — | — | — | — | — | — | 1.15 | 1.4 |
| 10 | 0.96 | 0.96 | 0.98 | 0.96 | 0.93 | 0.98 | 1.12 | 0.97 |
| 11 | — | 1.2 | 1.5 | — | −1.5 | — | 0.5 | 5 |

In the comparative experiment 1, the film 62 was torn from the portions pierced by the pins 121 in the tenter 64. Accordingly, ΔRe was not measured. In the comparative experiment 4, the film 62 was loosened and scratches are formed thereon, rendering the produced film 62 unsalable as a product. Therefore, ΔRe was not measured in both comparative experiments 4 and 6. According to the results shown in the Tables 1-1 and 1-2, the present invention achieves lower humidity dependence of the retardation Re and higher film production speed than those previously possible, despite that the existing production apparatuses are used.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A producing method of cellulose acylate film comprising the steps of:
(a) forming a casting film by continuously casting a dope containing cellulose acylate and a solvent from a casting die onto a casting surface of a cooled drum,
(b) peeling said casting film as a wet film from said drum after said casting film being solidified by cooling;
(c) drying said wet film using a drying device while said wet film being stretched in a width direction using holders, said holders holding side edge portions of said wet film; and
(d) drying said wet film while applying tension to said wet film in a width direction in a state that said side edge portions of said wet film being held, said step (d) being performed after said step (c),
wherein a first ratio calculated by (a moving speed (unit: m/min) of said holders)/(a rotation speed(unit: m/min) of said drum), a second ratio calculated by L2/L1, and a third ratio calculated by L3/L2 satisfy 0.94≦(said first ratio)/{(said second ratio)·(said third ratio)}≦0.97 when L1 is a width of said wet film before said stretching in said step (c), L2 is a width of said film after said stretching in said step (c), and L3 is a width of said film at the end of said step (d).

2. The producing method of claim 1, wherein said step (c) is ended before a residual solvent content of said wet film reaches 50%.

3. The producing method of claim 1, wherein said width L2 and said width L3 satisfy 0≦{(L2−L3)/L3}×100≦10.
